(19) United States
(12) Patent Application Publication
(10) Pub. No.: US 2026/0200454 A1
(43) Pub. Date: Jul. 16, 2026

(54) CONTROL SYSTEM FOR VEHICLE

(71) Applicant: TOYOTA JIDOSHA KABUSHIKI KAISHA, Toyota-shi (JP)

(72) Inventor: Ryo UENO, Toyokawa-shi (JP)

(73) Assignee: TOYOTA JIDOSHA KABUSHIKI KAISHA, Toyota-shi (JP)

(21) Appl. No.: 19/363,817

(22) Filed: Oct. 21, 2025

(30) Foreign Application Priority Data
Oct. 30, 2024 (JP) 2024-190914

(51) Int. Cl. B60W 10/06

(52) U.S. Cl. CPC B60W 10/06; B60W 2510/0604; B60W 2510/0633; B60W 2510/0638; B60W 2520/10; B60W 2540/106; B60W 2540/12

(57) ABSTRACT

A control system for a vehicle configured to prevent a reduction in acceleration response after decelerating the vehicle. The vehicle comprises an engine and a turbocharger, and a speed of the engine may be controlled irrespective of a speed of a drive wheel. The control system comprises a controller configured to: execute a speed control of the engine to maintain a supercharging pressure established by the turbocharger when the operating amount of the accelerator is reduced less than a predetermined threshold value; and increase the threshold value with an increase in a speed of the vehicle.

### CROSS-REFERENCE TO RELATED APPLICATIONS

The present disclosure claims the benefit of Japanese Patent Application No. 2024-190914 filed on Oct. 30, 2024 with the Japanese Patent Office, the disclosures of which are incorporated herein by reference in its entirety.

### BACKGROUND

### Field of the Disclosure

The embodiment of the present disclosure relates to the art of a control system for a vehicle having an engine provided with a supercharger for pressurizing air.

### Discussion of the Related Art

JP-A-2021-041869 discloses a control device for a hybrid vehicle in which an engine, a first motor, and an output shaft are connected to one another in a differential manner, and in which a second motor is connected to the output shaft in a torque transmittable manner. In the hybrid vehicle of this kind, an operating mode may be selected from a HV mode in which the hybrid vehicle is propelled by delivering a torque of the engine to drive wheels through the output shaft, and an EV mode in which the hybrid vehicle is propelled by only a torque of the second motor to the drive wheels while stopping the engine. For example, the operating mode is shifted from the EV mode to the HV mode when accelerating the hybrid vehicle.

Given that the hybrid vehicle engine is provided with a turbocharger driven by exhaust gas, acceleration response may be reduced due to turbo lag when the operating mode is switched from the EV mode to the HV mode. Therefore, the control device described in JP-A-2021-041869 is configured to generate a torque for compensating a shortage of the drive torque resulting from the turbo lag by the second motor.

However, the shortage of the drive torque resulting from the turbo lag may be greater than the maximum output torque of the second motor. Therefore, the control device described in JP-A-2021-041869 is configured to determine whether the maximum output torque of the second motor is less than the shortage of the drive torque associated with the turbo lag before shifting from the EV mode to the HV mode. In a case that the maximum output torque of the second motor is less than the shortage of the drive torque associated with the turbo lag, the control device taught by JP-A-2021-041869 starts the engine to increase a supercharging pressure before shifting the operating mode to the HV mode. According to the teachings of JP-A-2021-041869, a target speed of the engine before shifting to the HV mode is determined based on a pressure in an intake pipe, an acceleration demand, or an available electric power to be supplied from an electric storage device.

As described above, in the hybrid vehicle described in JP-A-2021-041869, the engine, the first motor, and the output shaft are connected to one another in the differential manner. Therefore, the speed of the engine may be changed arbitrarily irrespective of a rotational speed of the output shaft (that is, a speed of the vehicle). Basically, in the hybrid vehicles of this kind, the target speed of the engine is determined based on a required driving force and a speed of the vehicle. Therefore, when decelerating the hybrid vehicle traveling by transmitting the torque of the engine to the drive wheels, the speed of the engine is lowered close to an idling speed, or the engine is stopped. As a result, the supercharging pressure governed by the speed of the engine also decreases as reduction of the speed of the engine. For example, when the hybrid vehicle is temporarily decelerated to avoid collision with an obstacle or a preceding vehicle, the supercharging pressure is decreased and hence a response to accelerate the hybrid vehicle again may be reduced.

### SUMMARY

The embodiment of the present disclosure has been conceived noting the foregoing technical problems, and it is therefore an object of the present disclosure to provide a control system for a vehicle configured to prevent a reduction in an acceleration response after decelerating the vehicle.

According to the exemplary embodiment the present disclosure, there is provided a control system for a vehicle, comprising: an engine whose rotational speed may be controlled irrespective of a rotational speed of a drive wheel; a turbocharger that is arranged in the engine to pressurize air supplied to the engine in accordance with the rotational speed of the engine; an accelerator that is operated by a driver; and a controller that controls the engine in accordance with an operating amount of the accelerator. In order to achieve the above-explained objective, according to the exemplary embodiment of the present disclosure, the controller is configured to: execute a speed control of the engine to maintain a supercharging pressure established by the turbocharger when the operating amount of the accelerator is reduced less than a predetermined threshold value; and increase the threshold value with an increase in a speed of the vehicle.

In a non-limiting embodiment, the controller may be further configured to set a target speed of the engine to a higher speed with an increase in the speed of the vehicle during execution of the speed control.

In a non-limiting embodiment, the control system may further comprise a throttle valve that controls an amount of the air supplied to the engine. In addition, the controller may be further configured to set a target opening degree of the throttle valve to a larger value with an increase in the speed of the vehicle during execution of the speed control.

In a non-limiting embodiment, the controller may be further configured to execute the speed control when the supercharging pressure is reduced lower than a predetermined pressure.

In a non-limiting embodiment, the controller may be further configured to set the predetermined pressure to a higher value with an increase in the speed of the vehicle.

In a non-limiting embodiment, the controller may be further configured to terminate the speed control upon elapse of a predetermined time duration.

In a non-limiting embodiment, the controller may be further configured to set the predetermined time duration to a longer period of time with an increase in the speed of the vehicle.

In a non-limiting embodiment, the controller may be further configured to set the predetermined time duration to a longer period of time with an increase in the operating amount of the accelerator.

In a non-limiting embodiment, the control system may further comprise a brake device that is operated by the driver. In addition, the controller may be further configured to set the predetermined time duration to a shorter period of time with an increase in an operating force applied to the brake device.

As described, according to the exemplary embodiment of the present disclosure, a rotational speed of the engine may be controlled irrespective of rotational speeds of the drive wheels, and the turbocharger of the engine pressurizes the air supplied to the engine in accordance with the rotational speed of the engine. According to the exemplary embodiment of the present disclosure, therefore, a pressure of the air supplied to the engine (i.e., a supercharging pressure) may be controlled by controlling the speed of the engine. For this reason, a reduction in a response to increase a torque of the engine, that is, an acceleration response of the vehicle may be prevented by raising the supercharging pressure in advance.

In addition, the controller is configured to control the speed of the engine and the opening degree of the throttle valve to maintain the supercharging pressure when the operating amount of the accelerator is reduced less than the predetermined threshold value, and to increase the threshold value with an increase in a speed of the vehicle. According to the exemplary embodiment of the present disclosure, therefore, the speed control is executed in a situation where the vehicle traveling at a relatively high speed is temporarily decelerated and accelerated again to avoid a collision with an obstacle or a preceding vehicle. That is, the speed control may be executed in a situation where the vehicle decelerated temporarily is expected to be accelerated again or in a situation where the traveling noise is large. Therefore, even if a large engine noise is generated by executing the speed control, the driver will not feel uncomfortable sensation.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram showing one example of a structure of the vehicle to which the control system according to the exemplary embodiment of the present disclosure is applied;

FIG. 2 is a schematic illustration showing one example of a structure of the engine;

FIG. 3 is a block diagram showing functions of the controller:

FIG. 4 is a flowchart showing one example of a routine executed by the controller;

FIG. 5 is a flowchart showing one example of a subroutine for determining an execution of a motoring control;

FIG. 6 is a line chart showing one example of a first map for determining a depression threshold;

FIG. 7 is a flowchart one example of a subroutine for executing the motoring control;

FIG. 8 is a line chart showing one example of a second map for determining a target engine speed;

FIG. 9 is a line chart showing one example of a third map for determining a target opening degree of a throttle valve;

FIG. 10 is a line chart showing one example of a fourth map for determining a permissible time duration of the motoring control;

FIG. 11 is a time chart showing changes in a vehicle speed, a PAP, an engine speed, an opening degree of the throttle valve, and a supercharging pressure during execution of the routine shown in FIG. 4;

FIG. 12 is a flowchart showing another example of the subroutine shown in FIG. 5 configured to determining execution of the motoring control further based on a supercharging pressure;

FIG. 13 is a line chart showing one example of a fifth map for determining a supercharging pressure threshold; and

FIG. 14 is a line chart showing one example of a sixth map for determining a permissible time duration.

### DETAILED DESCRIPTION OF THE PREFERRED EMBODIMENT(S)

An embodiment of the present disclosure will now be explained with reference to the accompanying drawings. Note that the embodiments shown below are merely examples of the present disclosure, and do not limit the present disclosure.

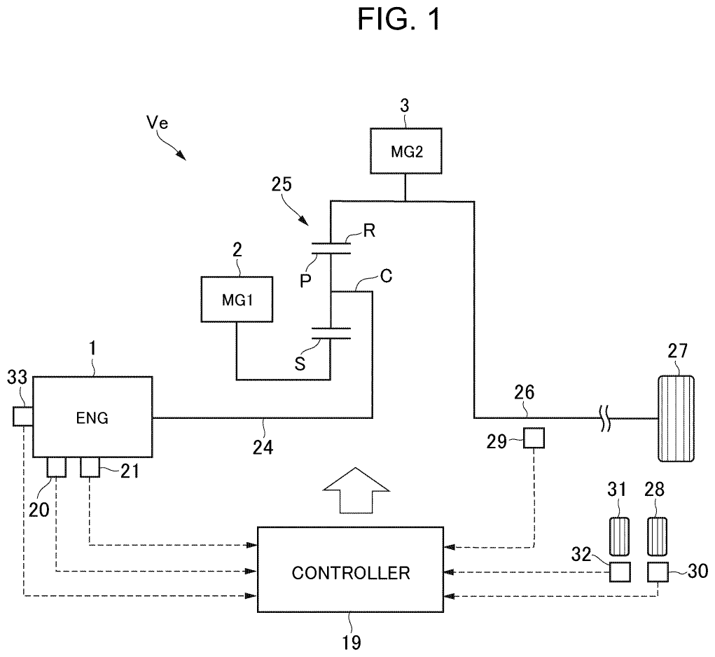

Referring now to FIG. 1, there is shown one example of a structure of a vehicle Ve to which the control system according to the exemplary embodiment of the present disclosure is applied. As illustrated in FIG. 1, the vehicle Ve is a hybrid vehicle in which a prime mover includes an engine (referred to as ENG in FIG. 1) 1, a first motor (referred to as MG1 in FIG. 1) 2, and a second motor (referred to as MG2 in FIG. 1) 3.

For example, a conventional gasoline engine and a diesel engine may be adopted as the engine 1. That is, the engine 1 generates power by burning an air/fuel mixture supplied thereto.

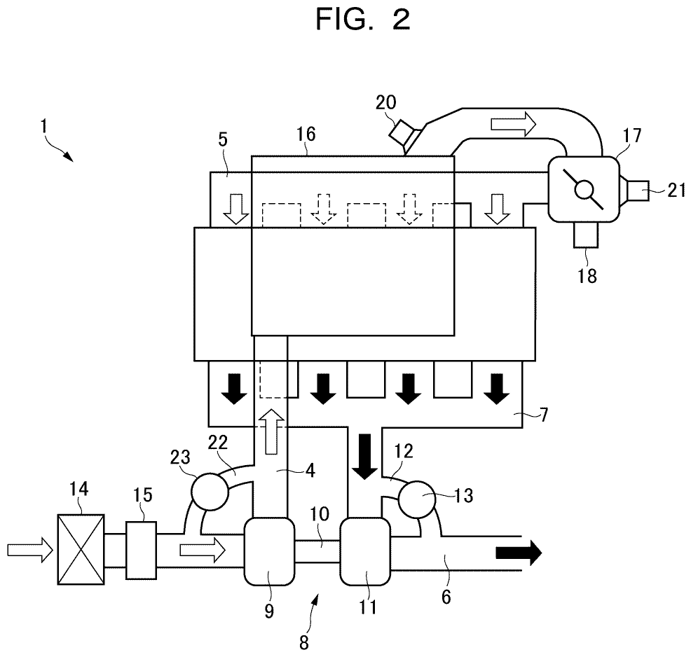

A structure of the engine 1 is illustrated in FIG. 2 in more detail. In the engine 1, an intake pipe 4 of an intake system is connected to an intake manifold 5 attached to the engine 1, and an exhaust pipe 6 of an exhaust system is connected to an exhaust manifold 7 attached to the engine 1.

The engine 1 is provided with a supercharger 8 that pressurizes air supplied to the engine 1. The supercharger 8 includes a compressor 9 arranged in the intake pipe 4 and a turbine 11 arranged in the exhaust pipe 6, and the turbine 11 is connected to the compressor 9 through a shaft 10. That is, the supercharger 8 is a conventional turbocharger having an exhaust gas turbine. Specifically, the turbine 11 is rotated by exhaust gas so that the compressor 9 is rotated at the same speed thereby pressurizing the intake air supplied to the engine 1. That is, since an amount of the exhaust gas increases with an increase in a speed of the engine 1, the supercharging pressure established by the turbocharger 8 increases with an increase in the speed of the engine 1.

In the engine 1 shown in FIG. 2, an exhaust bypass 12 is arranged to allow the exhaust gas to flow from upstream of the turbine 11 to downstream of the turbine 11 while detouring the turbine 11, and a wastegate valve 13 is arranged in the exhaust bypass 12 to control a ratio between the exhaust gas passing through the turbine 11 and the exhaust gas passing through the exhaust bypass 12. For example, the exhaust gas passing through the turbine 11 may be increased by reducing an opening degree of the wastegate valve 13.

In the intake pipe 4, an air cleaner 14 is arranged in an upstream section, and an air flow meter 15 is arranged between the air cleaner 14 and the compressor 9 to measure an amount of the intake air to the engine 1. In addition, an intercooler 16 as a heat exchanger is arranged downstream of the compressor 9. Specifically, the intercooler 16 is adapted to cool the intake air compressed by the turbocharger 8 by exchanging heat between the intake air and external air or cooling water.

In the intake pipe 4, a throttle valve 17 is arranged between the intercooler 16 and the intake manifold 5. The throttle valve 17 is activated by a motor 18, and a rotational angle of the throttle valve 17 (that is, a rotational angle of the motor 18) is controlled in accordance with a command signal transmitted from an after-mentioned controller 19 to regulate an amount of the air flowing through the intake pipe 4. In the following description, the rotational angle of the throttle valve 17 is referred to as an opening degree of the throttle valve 17.

In the intake pipe 4, a supercharging pressure sensor 20 is arranged between the intercooler 16 and the throttle valve 17 to detect a pressure in the intake pipe 4 downstream of the compressor 9, and an opening sensor 21 is arranged in the vicinity of the throttle valve 17 to detect an opening degree of the throttle valve 17.

In the intake pipe 4, a recirculation bypass 22 is arranged to allow the air to recirculate from downstream of the compressor 9 to upstream of the compressor 9 while detouring the compressor 9, and an air bypass valve 23 is arranged in the recirculation bypass 22. For example, when the opening degree of the throttle valve 17 is reduced abruptly, an occurrence of surge may be prevented by opening the air bypass valve 23 to protect he compressor 9.

The output torque of the engine 1 is controlled by a throttle valve 17, a fuel-injection device, an igniter (neither of which are shown), a wastegate valve 13 and so on.

In the vehicle Ve, a motor employed as a prime mover of a conventional electric vehicle or a hybrid vehicle may be adopted as each of the first motor 2 and the second motor 3. Each of the first motor 2 and the second motor 3 serves as a motor to generate a drive torque for increasing a rotational speed of the output shaft when an electric power is supplied thereto from an electric storage device (not shown), and serves as a generator to translate a power of the output shaft into an electric power at least partially when the output shaft thereof is rotated passively. For example, an AC motor such as a synchronous motor or an induction motor may be adopted as the first motor 2 and the second motor 3.

In the vehicle Ve shown in FIG. 1, a power split mechanism 25 is connected to an output shaft 24 of the engine 1. The power split mechanism 25 serves as a differential mechanism to distribute a torque generated by the engine 1 to the first motor 2 and an output shaft 26 connected to drive wheels 27. According to the exemplary embodiment of the present disclosure, a single-pinion planetary gear unit is adopted as the power split mechanism 25. Specifically, the power split mechanism 25 comprises a sun gear S, a ring gear R, a plurality of pinion gears P interposed between the sun gear S and the ring gear R, and a carrier C supporting the pinion gears P in a rotatable manner. In the power split mechanism 25, the sun gear S is connected to the first motor 2, the ring gear R is connected to the output shaft 26, and the carrier C is connected to the engine 1.

Therefore, the torque delivered from the engine 1 to the carrier C and the torque delivered from the first motor 2 to the sun gear S are balanced to deliver torque to the ring gear R while maintaining rotational speeds of the engine 1 and the first motor 2. That is, when the first motor 2 generates torque greater than the torque acting on the sun gear S in accordance with the torque delivered from the engine 1 to the carrier C and a gear ratio of the power split mechanism 25, a rotational speed of the engine 1 is lowered in accordance with a difference between the torque acting on the sun gear S and the torque generated by the first motor 2. By contrast, when the torque of the first motor 2 is less than the torque acting on the sun gear S in accordance with the torque delivered from the engine 1 to the carrier C and the gear ratio of the power split mechanism 25, a rotational speed of the engine 1 is raised in accordance with the difference between the torque acting on the sun gear S and the torque generated by the first motor 2. In other words, a rotational speed of the engine 1 may be varied continuously by controlling the (reaction) torque of the first motor 2. That is, the power split mechanism 25 serves as a continuously variable transmission that adjusts a rotational speed of the engine 1 to a desired speed irrespective of a rotational speed of the output shaft 26 (that is, a rotational speed of the drive wheel 27).

Specifically, the first motor 2 serves as a motor when generating reaction torque in a direction in which a rotational speed thereof is increased. By contrast, the first motor 2 serves as a generator when generating reaction torque in a direction in which a rotational speed thereof the first motor 2 is reduced.

As described above, the second motor 3 is connected to the ring gear R. Therefore, when the torque delivered to the ring gear R from the engine 1 through the power split device 25 is smaller than torque required to propel the vehicle Ve, the second motor 3 is operated as a motor to generate torque. By contrast, when the torque delivered to the ring gear R from the engine 1 through the power split device 25 is larger than the torque required to propel the vehicle Ve, the second motor 3 is operated as a generator to reduce the torque.

The first motor 2 and the second motor 3 are electrically connected to each other through an inverter (not shown) so that electric power generated by one of the first motor 2 and the second motor 3 may be supplied to the other one of the motors. In other words, the electric power corresponding to a difference between a total electric power consumed by the first motor 2 and the second motor 3 and a total electric power generated by the first motor 2 and the second motor 3 is supplied from or accumulated in the electric storage device.

As an optional extra, another transmission mechanism such as a geared transmission may be connected to the output shaft 26. In addition, an output gear may be connected to the ring gear R instead of the output shaft 26, and the drive wheels 27 may be connected to the ring gear R through a gear train meshing with the output gear.

An operating mode of the vehicle Ve may be selected from an Electric Vehicle mode (hereinafter abbreviated as the EV mode) in which the engine 1 is stopped and the vehicle Ve is propelled only by the power of the second motor 3, and a Hybrid Vehicle mode (hereinafter abbreviated as the HV mode) in which the engine 1 is activated and the vehicle Ve is propelled at least by the engine 1. In the HV mode, a power required to propel the vehicle Ve and a power required to charge the electric storage device are obtained based on an operating amount (i.e., a position or depression) of an accelerator (i.e., an accelerator pedal) 28 operated by the driver and a speed of the vehicle Ve, and a total value of these powers is employed as a required power to be generated by the engine 1.

Then, a required torque to be generated by the engine 1 and a target speed of the engine 1 are obtained based on the required power to be generated by the engine 1 with reference to an optimally fuel efficient map, and an opening degree of the throttle valve 17, an amount of fuel injection, an ignition timing, an opening degree of the wastegate valve 13 are controlled in accordance with the obtained required torque to be generated by the engine 1. In addition, the speed of the engine 1 is adjusted to the target speed by controlling the reaction torque of the first motor 2.

The engine 1 and the motors 2 and 3 are controlled by an electronic control unit (hereinafter referred to as a controller) 19 comprising a microcomputer. The controller 19 performs calculation based on incident signals transmitted from various sensors using arithmetic expressions and maps stored therein, and calculation results are transmitted from the controller 19 to the engine 1, the first motor 2, and the second motor 3 in the form of command signal.

For example, as shown in FIG. 1, signals are transmitted to the controller 19 from a vehicle speed sensor 29 that detects a speed of the vehicle Ve, an accelerator sensor 30 that detects a position of the accelerator pedal 28, a pedal force sensor 32 that detects an operating force (i.e., a pedal force) applied to a brake device (brake pedal) 31 by the driver, a crank angle sensor 33 that detects a speed of the engine 1, an opening sensor 21 that detects an opening degree of the throttle valve 17, and a supercharging pressure sensor 20 that detects a supercharging pressure.

The control system according to the exemplary embodiment of the present disclosure is configured to prevent a reduction in the acceleration response in a situation where the vehicle Ve is temporarily decelerated and then accelerated again. In other words, when the vehicle Ve is temporarily decelerated, the control system maintains supercharging pressure by either keeping a speed of the engine 1 to a high speed or keeping the throttle valve 17 open to a large degree thereby maintaining an amount of the air flowing through the turbine 11.

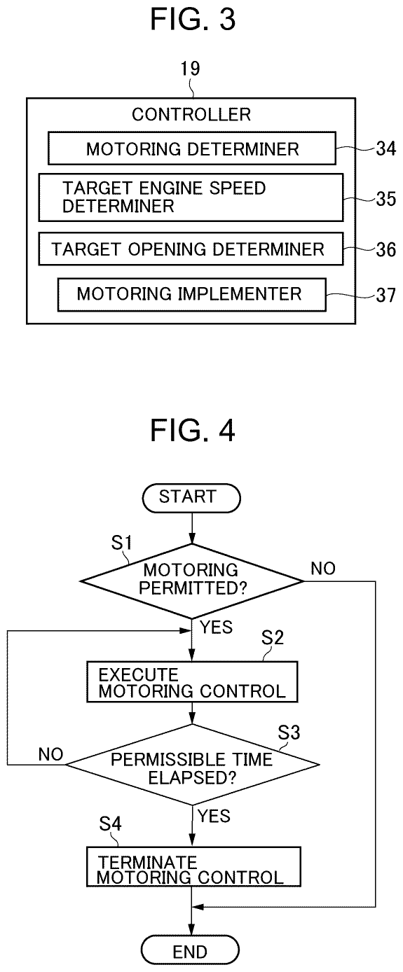

Functions of the controller 19 are shown in FIG. 3. As shown i FIG. 3, the controller 19 comprises a motoring determiner 34, a target engine speed determiner 35, a target opening determiner 36, and a motoring implementer 37.

The motoring determiner 34 is configured to determine whether or not to permit an execution of a motoring control as a speed control of the embodiment to increase a speed of the engine 1 higher than a speed obtained based on a position of the accelerator pedal 28 and a speed of the vehicle Ve when decelerating the vehicle Ve.

In order to improve the acceleration response when accelerating the temporarily decelerated vehicle Ve again, the target engine speed determiner 35 is configured to calculate a target speed of the engine 1 during execution of the motoring control, and the target opening determiner 36 calculates a target opening degree of the throttle valve 17 during execution of the motoring control.

The motoring implementer 37 is configured to control the first motor 2 and the motor 18 so as to achieve the target speed of the engine 1 determined by the target engine speed determiner 35 and the target opening degree of the throttle valve 17 determined by the target opening determiner 36 when the motoring determiner 34 determines to execute the motoring control.

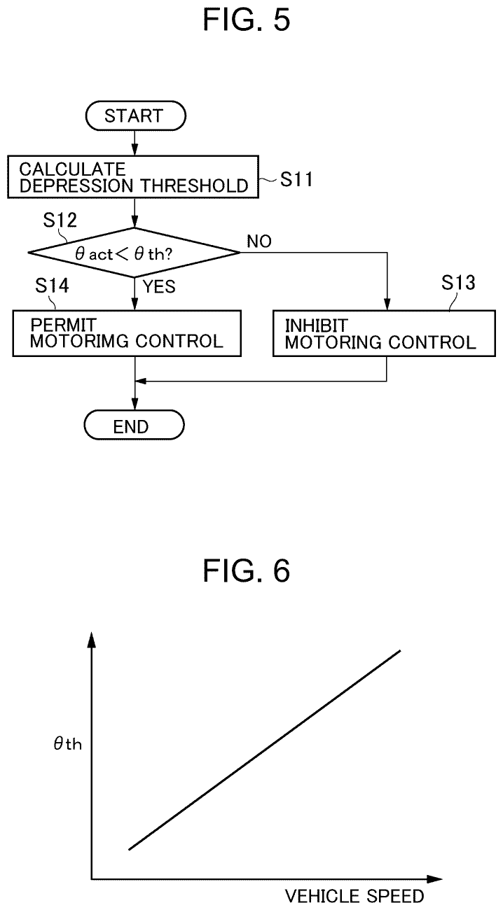

Turning to FIG. 4, there is shown one example of a routine executed by the controller 19. The routine shown in FIG. 4 is executed when the vehicle Ve is propelled in the HV mode at a predetermined speed or higher. That is, the routine shown in FIG. 4 is executed when a position of the accelerator pedal 28 is at a predetermined position or deeper. At step S1, it is determined whether or not to permit the execution of the motoring control. Specifically, such determination is made by executing the subroutine shown in FIG. 5 by the motoring determiner 34.

At step S11 of the subroutine shown in FIG. 5, a threshold value θth of a depression of the accelerator pedal 28 (hereinafter, referred to as the depression threshold) for determining whether to permit the motoring control is calculated. Specifically, the depression threshold θth as a predetermined threshold value of the exemplary embodiment of the present disclosure is obtained based on a speed of the vehicle Ve detected by the vehicle speed sensor 29 with reference to a first map shown in FIG. 6 stored in the controller 19.

In the first map shown in FIG. 6, the horizontal axis represents a speed of the vehicle Ve, and the vertical axis represents the depression threshold θth. As shown in FIG. 6, the depression threshold θth increases with an increase in the speed of the vehicle Ve. In a situation where the vehicle Ve traveling at a high speed is decelerated by returning the accelerator pedal 28, the vehicle Ve is expected to be accelerated again to a speed before decelerating the vehicle Ve. In this case, in order to improve the acceleration response when accelerating the vehicle Ve again, in other words, in order to prevent a reduction in a speed of the engine 1 (that is, a supercharging pressure) with a reduction in the speed of the vehicle Ve, it is necessary to execute the motoring control immediately. To this end, the depression threshold θth is increased with an increase in the speed of the vehicle Ve. Whereas, in a situation where the vehicle Ve traveling at a low speed is decelerated by returning the accelerator pedal 28, a drive torque required to accelerate the vehicle Ve again is small. Otherwise, the vehicle Ve is expected to be stopped without being accelerated. In this case, it is not necessary to execute the motoring control to prevent an increase in a load on the first motor 2 controlling the speed of the engine 1 and a load on the electric storage device exchanging electric power with the first motor 2. Therefore, the depression threshold θth is reduced with a reduction in the speed of the vehicle Ve.

Specifically, the depression threshold θth is set larger than an idle-off threshold but smaller than a braking threshold. The idle-off threshold is a criterion of a position of the accelerator pedal 28 for determining that the engine 1 will be stopped, in other words, for determining that the speed of the engine 1 is reduced to zero. For this purpose, the idle-off threshold is set to an initial position of the accelerator pedal 28 or a position slightly deeper than the initial position. On the other hand, the braking threshold is a criterion of a position of the accelerator pedal 28 for determining that it is required to apply a braking force to the vehicle Ve, and the braking threshold is determined with reference to a driving force map employed in conventional vehicles. The driving force map is configured to determine the driving force and the braking force required for the vehicle Ve based on a speed of the vehicle Ve and a position of the accelerator pedal 28. Specifically, the driving force map is configured to decrease the driving force or increase the braking force with an increase in the speed of the vehicle Ve in a situation where the position of the accelerator pedal 28 is constant, and to increase the driving force or decrease the braking force with an increase in depression of the accelerator pedal 28 in a situation where the speed of the vehicle Ve is constant. That is, the braking force is required in the situation where the vehicle Ve is traveling at a predetermined speed and a position of the accelerator pedal 28 is shallower than the predetermined position.

Then, at step S12, it is determined whether or not an actual position θact of the accelerator pedal 28 is shallower than the depression threshold θth. In other words, at step S12, it is determined whether or not the actual depression θact of the accelerator pedal 28 has been reduced smaller than the depression threshold θth. If the actual position θact of the accelerator pedal 28 is deeper than the depression threshold θth so that the answer of step S12 is NO, the routine progresses to step S13 to inhibit the execution of the motoring control, and thereafter returns. By contrast, if the actual position θact of the accelerator pedal 28 is shallower than depression threshold θth so that the answer of step S12 is YES, the routine progresses to step S14 to permit the execution of the motoring control, and thereafter returns.

If the execution of the motoring control is inhibited (that is, not permitted) at step S13 of the subroutine shown in FIG. 5 so that the answer of step S1 is NO, the routine returns. In this case, an operating point of the engine 1 is determined based on the position of the accelerator pedal 28 and the speed of the vehicle Ve, and the engine 1 and the first motor 2 are controlled to operate the engine 1 at the determined operating point. By contrast, if the execution of the motoring control is permitted at step S14 of the subroutine shown in FIG. 5 so that the answer of step S1 is YES, the routine progresses to step S2 to execute the motoring control.

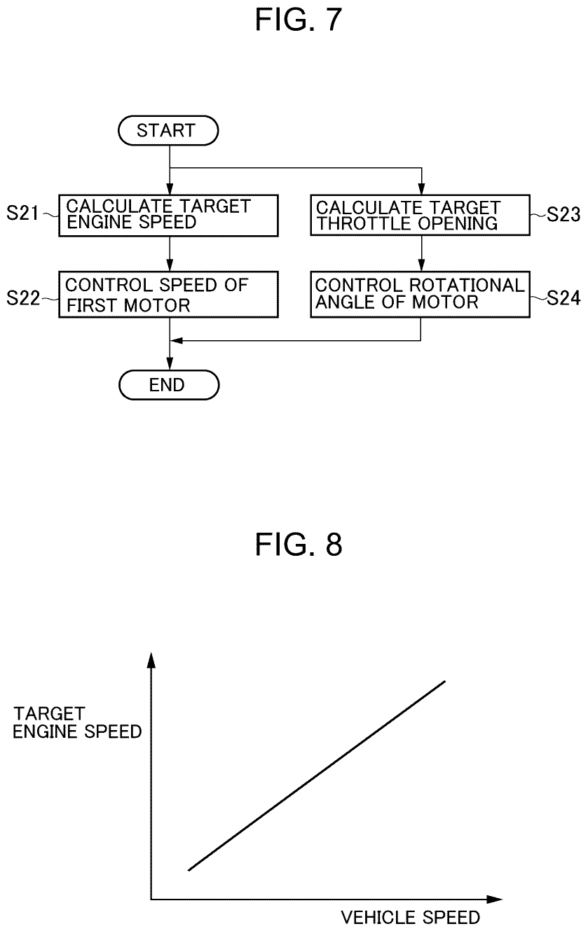

The motoring control is executed to control an amount of the air flowing toward the turbine 11 so as to maintain the supercharging pressure. Specifically, the motoring control is executed by maintaining the speed of the engine 1 at a predetermined speed by the first motor 2, and maintaining an opening degree of the throttle valve 17 at a predetermined degree by the motor 18. For these purposes, the controller 19 executes the subroutine shown in FIG. 7.

The subroutine shown in FIG. 7 is executed when the execution of the motoring control is permitted by the motoring determiner 34. At step S21, a target speed of the engine 1 for maintaining the supercharging pressure is calculated based on the speed of the vehicle Ve detected by the vehicle speed sensor 29 with reference to a second map shown in FIG. 8 that is stored in the controller 19. Specifically, the second map is configured to increase the target speed of the engine 1 with an increase in the speed of the vehicle Ve. In other words, the target speed of the engine is set to a higher speed with an increase in the speed of the vehicle Ve. The target speed of the engine 1 is determined such that a sound of the engine 1 is suppressed to or lower than a sound pressure of a traveling sound generated according to the speed of the vehicle Ve. Thereafter, at step S22, the speed of the first motor 2 is controlled to adjust the speed of the engine 1 to the target speed, and the routine returns.

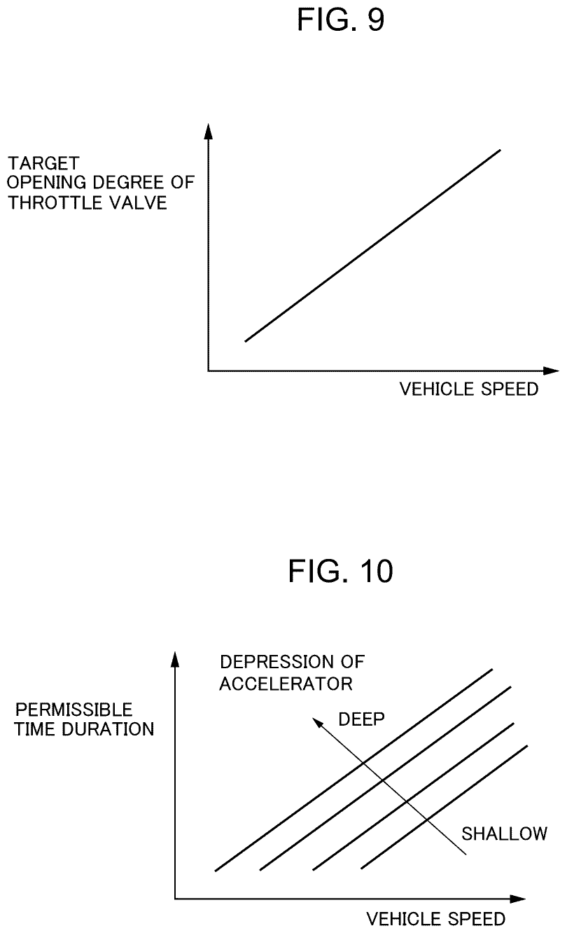

At the same time, a target opening degree of the throttle valve 17 for maintaining the supercharging pressure is calculated at step S23 based on the speed of the vehicle Ve detected by the vehicle speed sensor 29 with reference to a third map shown in FIG. 9 that is stored in the controller 19. Specifically, the third map is configured to increase the target opening degree of the throttle valve 17 with an increase in the speed of the vehicle Ve. That is, the target opening degree of the throttle valve 17 is set to a larger value with an increase in the speed of the vehicle Ve. In a case that the speed of the vehicle Ve is high, the speed of the engine 1 is maintained to a high speed. In this case, the air rapidly flows from the intake pipe 4 into the exhaust pipe 6 through the engine 1, and as a result, an internal pressure of the intake pipe 4 is lowered. Therefore, in order to maintain the supercharging pressure, a large amount of air is taken into the intake pipe 4. To this end, the target opening degree of the throttle valve 17 is increased with an increase in the speed of the vehicle Ve. Thereafter, at step S24, a rotational angle of the motor 18 is controlled to adjust the opening degree of the throttle valve 17 to the target opening degree, and the routine returns.

After executing the motoring control, it is determined at step S3 whether or not a permissible time duration has elapsed. Specifically, the permissible time duration is set based on a position of the accelerator pedal 28 and a speed of the vehicle Ve, to a length in which the loads on the first motor 2 and the electric storage device will not be increased even if the motoring control is continued to the end of the permissible time duration, and in which the driver will not feel a strange sensation by a high speed of the engine 1 in a case that the vehicle Ve will not be accelerated again.

An example of a fourth map for determining the permissible time duration is shown in FIG. 10. In the fourth map, the horizontal axis represents a speed of the vehicle Ve, the vertical axis represents the permissible time duration, and a plurality of lines corresponding to positions of the accelerator pedals 28 are drawn. As can be seen from in FIG. 10, the permissible time duration is set longer with an increase in the speed of the vehicle Ve. In a case that the speed of the vehicle Ve is high, it takes long time to decelerate the vehicle Ve sufficiently. Therefore, the permissible time duration is increased with an increase in the speed of the vehicle Ve. In addition, the driver may be prevented from sensing a noise during execution of the motoring control by setting the permissible time duration to a longer period of time. The permissible time duration is also set longer with an increase in a depression of the accelerator pedal 28. In a situation where the driver depresses the accelerator pedal 28, it is assumed that the driver intends to accelerate the vehicle Ve again. Therefore, in order to maintain the supercharging pressure as long as the driver depresses the accelerator pedal 28, the permissible time duration is set longer with an increase in a depression of the accelerator pedal 28.

If the permissible time duration has not yet elapsed so that the answer of step S3 is NO, the routine returns to step S2. By contrast, if the permissible time duration has elapsed so that the answer of step S3 is YES, the routine progresses to step S4 to terminate the motoring control, and thereafter returns. In this case, the speed of the engine 1 and the opening degree of the throttle valve 17 are decreased immediately to the target speed and the target opening degree determined based on a position of the accelerator pedal 28 and a speed of the vehicle Ve.

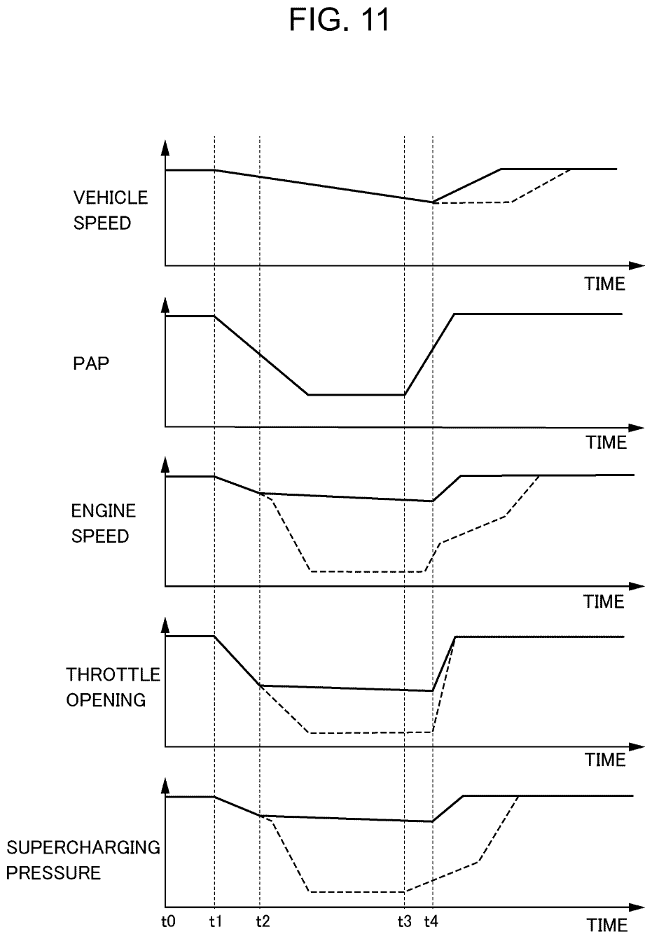

In FIG. 11, changes in a speed of the vehicle Ve, a position of the accelerator pedal 28 (referred to as PAP in FIG. 11), a speed of the engine 1, an opening degree of the throttle valve 17, and a supercharging pressure during execution of the routine shown in FIG. 4 are indicated by the solid curves. At point t0, the accelerator pedal 28 is maintained to a predetermined position to propel the vehicle Ve at a constant speed. In this situation, therefore, a speed of the engine 1, an opening degree of the throttle valve 17, and a supercharging pressure are constant. At point t1, the accelerator pedal 28 is started to be returned, and consequently the speed of the vehicle Ve is reduced gradually by a traveling resistance. As described above, the engine 1 is controlled based on the operating point governed by a position of the accelerator pedal 28 and a speed of the vehicle Ve. In this situation, therefore, the speed of the engine 1 and the opening degree of the throttle valve 17 are reduced from point t1. Consequently, an amount of the exhaust gas of the engine 1 is reduced thereby reducing the supercharging pressure from point t1.

The depression of the accelerator pedal 28 is reduced smaller than depression threshold θth at the point t2 so that the execution of the motoring control is permitted. Therefore, the speed of the engine 1 and the opening degree of the throttle valve 17 are controlled based on the speed of the vehicle Ve from point t2 so as to maintain the supercharging pressure. In this situation, since it is not necessary to operate the engine 1, fuel supply to the engine 1 is stopped. As a result, the speed of the vehicle Ve is reduced continuously, and the speed of the engine 1 and the opening degree of the throttle valve 17 are reduced at a relatively low rate in association with such reduction in the speed of the vehicle Ve.

In FIG. 11, changes in a speed of the vehicle Ve, a speed of the engine 1, an opening degree of the throttle valve 17, and a supercharging pressure of a case in which the motoring control is not executed are indicated by the broken curves. In the case that the motoring control is not executed, the speed of the engine 1 and the opening degree of the throttle valve 17 decrease continuously even after point t2, and consequently the supercharging pressure is reduced. In this case, the speed of the engine 1 is continuously reduced to the idling speed or until the engine 1 stops.

The accelerator pedal 28 is depressed again at point t3, and the depression of the accelerator pedal 28 exceeds the depression threshold θth at point t4. In this situation, therefore, execution of the motoring control is inhibited, and the speed of the engine 1 and the opening degree of the throttle valve 17 are controlled based on the position of the accelerator pedal 28 and the speed of the vehicle Ve. Consequently, the speed of the engine 1 and the opening degree of the throttle valve 17 are increased from the point t4 with an increase in the depression of the accelerator pedal 28. In this situation, therefore, the supercharging pressure is increased from point t4 so that the torque of the engine 1 is increased rapidly to increase the speed of the vehicle Ve.

Whereas, in the case that the motoring control is not executed, the engine 1 is stopped and the throttle valve 17 is closed in this situation. In this case, therefore, the engine 1 is cranked when the depression of the accelerator pedal 28 increases at point t3, then the engine 1 is started, and thereafter the speed of the engine 1 increases. Thus, in this case, it takes longer time until the supercharging pressure is increased. Therefore, the timing at which the speed of the vehicle Ve starts to increase is delayed.

As described above, since the engine 1 is connected to the drive wheels 27 through the power split mechanism 25 serving as a continuously variable transmission, the speed of the engine 1 may be controlled independently of the speed of the drive wheels 27. In addition, the turbocharger 8 of the engine 1 pressurizes air to be supplied to the engine 1 in accordance with a speed of the engine 1. That is, the pressure of the air supplied to the engine 1 (that is, supercharging pressure) may be controlled by controlling the speed of the engine 1. Therefore, the turbocharger 8 may be activated to increase the supercharging pressure in advance by controlling the speed of the engine 1 and the opening degree of the throttle valve 17 even when decelerating the vehicle Ve. For this reason, it is possible to prevent a reduction in the acceleration response when increasing the torque of the engine 1 to accelerate the temporarily decelerated vehicle Ve again.

As described, the motoring control is executed when the depression of the accelerator pedal 28 is reduced smaller than the depression threshold θth, and depression threshold θth is increased with an increase in the speed of the vehicle Ve. Therefore, the motoring control may be executed in a situation where the vehicle Ve traveling at a relatively high speed is temporarily decelerated and accelerated again to avoid a collision with an obstacle or a preceding vehicle. That is, the motoring control may be executed in a situation where the vehicle Ve decelerated temporarily is expected to be accelerated again or in a situation where the traveling noise is large. Therefore, even if a large engine noise is generated by executing the motoring control, the driver will not feel uncomfortable sensation.

In addition, the power split mechanism 25 is adapted to control the speed of the engine 1 by the first motor 2. Specifically, in order to execute the motoring control, the first motor 2 generates the driving torque in the direction to increase the speed thereof or the regenerative torque in the direction to decrease the speed thereof. Therefore, in the situation where the vehicle Ve decelerated temporarily is expected to be accelerated again, increase in the loads on the first motor 2 and the electric storage device may be prevented by executing the motoring control.

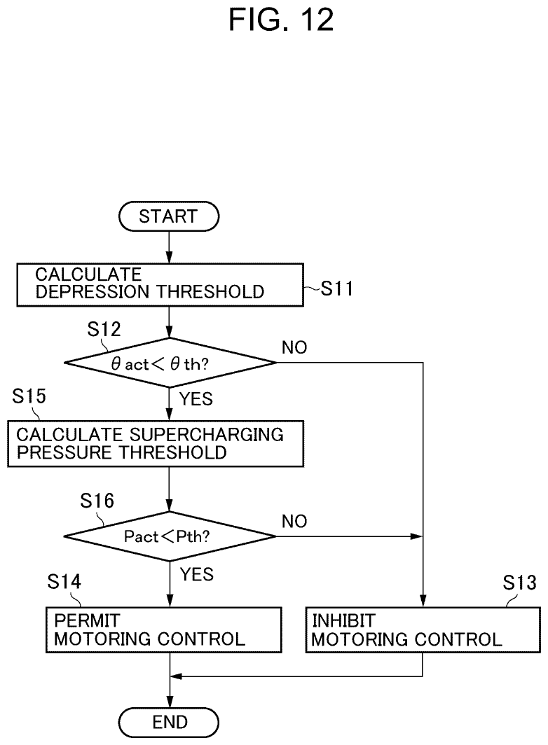

In order to maintain the supercharging pressure according to the speed of the vehicle Ve accelerating the decelerated vehicle Ve again, the control system according to the exemplary embodiment of the present disclosure may be further configured to determine whether or not to permit the execution of the motoring control based on the supercharging pressure in addition to the position of the accelerator pedal 28. In this case, the control system executes the modified subroutine shown in FIG. 12. In the following description, explanations for the steps in common with those of the routine shown in FIG. 5 will be omitted.

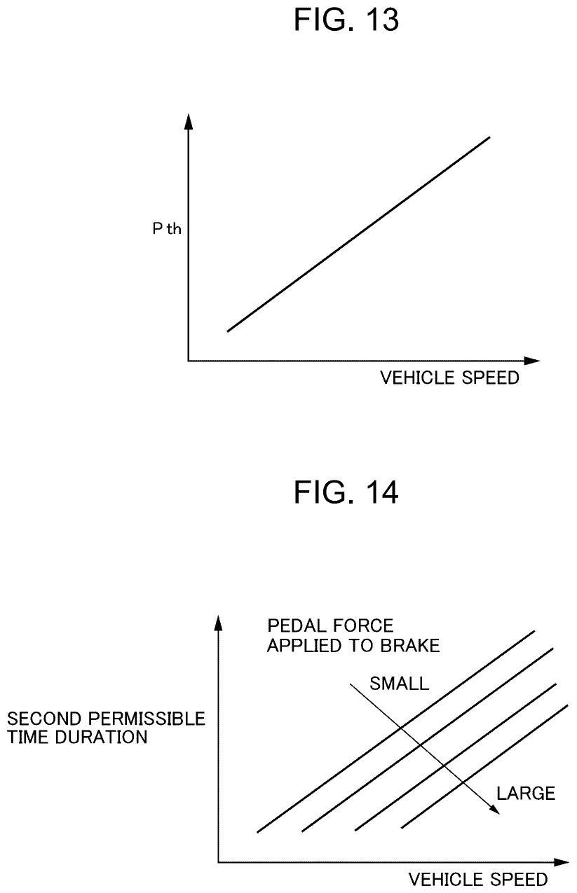

According to the routine shown in FIG. 12, if the answer of the step S12 is YES, the routine progresses to step S15 to calculate a supercharging pressure threshold Pth based on a speed of the vehicle Ve detected by the vehicle speed sensor 29 with reference to the fifth map shown in FIG. 13 that is stored in the controller 19.

In the fifth map, the horizontal axis represents the speed of the vehicle Ve, and the vertical axis represents the supercharging pressure threshold Pth. As can be seen from FIG. 13, the supercharging pressure threshold Pth increases with an increase in the speed of the vehicle Ve. In other words, the supercharging pressure threshold Pth is set to a higher value with an increase in the speed of the vehicle Ve. This is because the supercharging pressure is increased with an increase in the speed of the vehicle Ve during steady running. That is, the supercharging pressure threshold Pth is set to maintain the supercharging pressure corresponding to the speed of the vehicle Ve at a point when the accelerator pedal 28 is depressed and the engine 1 is required to be driven.

Then, it is determined at step S16 whether or not an actual supercharging pressure Pact is less than the supercharging pressure threshold Pth. In other words, it is determined whether or not the actual supercharging pressure Pact has been reduced less than the supercharging pressure threshold Pth. If the actual supercharging pressure Pact is equal to or higher than the supercharging pressure threshold Pth so that the answer of step S16 is NO, the routine progresses to step S13 to inhibit the motoring control, and thereafter returns. By contrast, if the actual supercharging pressure Pact is less than the supercharging pressure threshold Pth so that the answer of step S16 is YES, the routine progresses to step S14 to permit the execution of the motoring control, and thereafter returns.

By thus determining whether to permit the execution of the motoring control based on the supercharging pressure, the motoring control will not be executed even if the accelerator pedal 28 is returned abruptly in a condition where the speed of the engine 1 and the supercharging pressure are still high. For this reason, it is possible to prevent an abrupt increase in the load on the first motor 2 maintaining the speed of the engine 1 during execution of the motoring control.

The control system according to the exemplary embodiment of the present disclosure may be further configured to terminate the motoring control upon elapse of a second permissible time duration set based on a depression of the brake pedal 31 and the speed of the vehicle Ve, in addition to the above-mentioned permissible time duration.

One example of a sixth map for setting the second permissible time duration is shown in FIG. 14. In the sixth map, the horizontal axis represents the speed of the vehicle Ve, the vertical axis represents the second permissible time duration, and a plurality of lines corresponding to pedal forces applied to the brake pedal 31 are drawn. As can be seen from FIG. 14, the second permissible time duration is set longer with an increase in the speed of the vehicle Ve. In a case that the speed of the vehicle Ve is high, it takes long time to decelerate the vehicle Ve sufficiently. Therefore, the second permissible time duration is set longer with an increase in the speed of the vehicle Ve. In addition, the driver may be prevented from being frustrated by the noise during execution of the motoring control by setting the second permissible time duration to a longer period of time. Whereas, the second permission time is set to a shorter period of time with an increase in the pedal force applied to the brake pedal 31. In a situation where the pedal force applied to the brake pedal 31 is large, the vehicle Ve is expected to be promptly accelerated again. In addition, in a situation where the vehicle Ve is decelerated abruptly, the driver may be frustrated by the noise during execution of the motoring control. Therefore, the second permission time is set shorter with an increase in the pedal force applied to the brake pedal 31.

The control system according to the exemplary embodiment of the present disclosure may also be applied to a series hybrid vehicle in which an engine that does not deliver torque to drive wheels and is connected to a generator, and in which electric power generated by the generator is supplied to a drive motor. In addition, the control device according to the exemplary embodiment of the present disclosure may also be applied to an engine vehicle in which only an engine serves as a prime mover, and in which a speed ratio between the engine and drive wheels may be varied continuously a continuously variable transmission.

In addition, the engine 1 may be provided with a supercharger driven by power of the output shaft of the engine 1 instead of the turbocharger driven by the exhaust gas. In this case, the motoring control may be executed by controlling a speed of the engine 1 without controlling an opening degree of the throttle valve 17.

What is claimed is:

1. A control system for a vehicle, comprising:
an engine whose rotational speed may be controlled irrespective of a rotational speed of a drive wheel;
a turbocharger that is arranged in the engine to pressurize air supplied to the engine in accordance with the rotational speed of the engine;
an accelerator that is operated by a driver; and
a controller that controls the engine in accordance with an operating amount of the accelerator,
wherein the controller is configured to
execute a speed control of the engine to maintain a supercharging pressure established by the turbocharger when the operating amount of the accelerator is reduced less than a predetermined threshold value, and
increase the threshold value with an increase in a speed of the vehicle.

2. The control system for the vehicle as claimed in claim 1, wherein the controller is further configured to set a target speed of the engine to a higher speed with an increase in the speed of the vehicle during execution of the speed control.

3. The control system for the vehicle as claimed in claim 1, further comprising:
a throttle valve that controls an amount of an air supplied to the engine,
wherein the controller is further configured to set a target opening degree of the throttle valve to a larger value with an increase in the speed of the vehicle during execution of the speed control.

4. The control system for the vehicle as claimed in claim 1, wherein the controller is further configured to execute the speed control when the supercharging pressure is reduced lower than a predetermined pressure.

5. The control system for the vehicle as claimed in claim 4, wherein the controller is further configured to set the predetermined pressure to a higher value with an increase in the speed of the vehicle.

6. The control system for the vehicle as claimed in claim 1, wherein the controller is further configured to terminate the speed control upon elapse of a predetermined time duration.

7. The control system for the vehicle as claimed in claim 6, wherein the controller is further configured to set the predetermined time duration to a longer period of time with an increase in the speed of the vehicle.

8. The control system for the vehicle as claimed in claim 6, wherein the controller is further configured to set the predetermined time duration to a longer period of time with an increase in the operating amount of the accelerator.

9. The control system for the vehicle as claimed in claim 6, further comprising:
a brake device that is operated by the driver,
wherein the controller is further configured to set the predetermined time duration to a shorter period of time with an increase in an operating force applied to the brake device.
